(19) United States
(12) Patent Application Publication
(10) Pub. No.: US 2010/0174738 A1
(43) Pub. Date: Jul. 8, 2010

(54) METHOD AND SYSTEM FOR ENERGY BALANCE CONTROL

(75) Inventor: Nathalie Bekx, Edegem (BE)

Correspondence Address: Jerold I. Schneider, 525 Okeechobee Blvd., Suite 1500, West Palm Beach, FL, 33401, US

(73) Assignee: XENARJO, Mechelen (BE)

(21) Appl. No.: 12/557,075

(22) Filed: Sep. 10, 2009

(30) Foreign Application Priority Data
Jan. 6, 2009 (BE) 2009/0007

(51) Int. Cl. G06F 17/30

(52) U.S. Cl. 707/769; 707/803; 707/E17.005; 707/E17.014

(57) ABSTRACT

System and method for controlling an energy balance of an individual by offsetting at least part of the energy absorbed when consuming a food product by expending a suitable amount of energy in exercise activity.

### CROSS-REFERENCE TO RELATED APPLICATIONS

This application is a claims priority to Belgian Application No. 2009/0007, filed Jan. 6, 2009, which is incorporated herein by reference in its entirety.

### BACKGROUND

This invention relates to a method and system to control an individual's energy balance and to a method and system to select one or more food products based on an individual's health profile.

Market research carried out by Bexpertise (Fedis Retail Barometer 2007) showed that consumers often barely understand the information provided on the packaging of (‘functional’) food products, the major reason being the use of incomprehensible or unfathomable terminology. As a result of this ambiguity consumers lose time when choosing food products, they buy products that are too expensive because they can't compare enough, they buy food products that don't always meet their specific needs or health patterns, . . .

Over the years, several methods have been developed which permit controlling control food product energy absorption in order to restrict body weight.

U.S. Pat. No. 6,436,036 describes a method that allocates point totals to food products based on properties such as their kcal content, fat content and fibre content. This point total may be shown on the packaging or should be calculated by the consumer based on the information available on the packaging. The method states that the food points total for a certain period must be smaller or equal to an enforced maximum points total. This enforced maximum points total is calculated based on the consumer's weight and can be increased based on exercise activities performed by the consumer. The calculation of this maximum points total is based on complex formulas and calculations to be carried out by the consumer based on properties such as weight, activity period and activity intensity. This method indirectly recognises the purpose of exercise activities to offset energy absorbed through food products, as the enforced maximum points total can be increased by taking into account physical activities performed by the consumer. However, the method does not provide a direct link between the energy absorbed through a certain food product on the one hand and a certain activity that is required to offset the energy absorbed through the food product on the other hand. The method therefore does not allow the user to control his or her energy balance, i.e. the balance between the energy absorbed through food and the energy spent in exercise activities. The method imposes complicated calculations and formulas on the consumer, which include an ‘activity intensity’ factor. Activity intensity is a subjective factor and can be interpreted differently by different users, so calculations may vary depending on the user.

Summarizing, the existing methods have the disadvantage that too much focus is put on the restriction of the types and quantities of ingested food products, so that consumers find them difficult to sustain in the long term. The existing methods also do not allow making a direct correlation between the individual's ingested food products and his or her exercise activities. One of the objectives of the existing methods is often to ingest as few kcalories as possible, i.e. food products with low energy contents, which often leads to a one-sided food pattern.

### DETAILED DESCRIPTION

It is therefore an aim of the invention to provide a method with which energy absorption through food may be controlled based on clear, quickly recognisable and reliable food information that also contributes to a balanced and healthy lifestyle.

This problem is solved by this invention by applying a method and system that controls an individual's energy balance on the one hand and by selecting food products based on an individual's health profile on the other hand.

A first aspect of the invention relates to a method and system to control an individual's energy balance upon consuming a food product. This is made possible by providing a direct link between the absorbed energy through consumption of the food product on the one hand, and the energy expenditure through exercise on the other hand.

With energy balance is meant the balance between the amount of energy absorbed through food products on the one hand and the amount of energy expended through physical activity on the other hand. The term food products includes solid food products as well as drinks, i.e. liquid food products.

In a first step, the method according to the invention allocates a code to food products depending on their energy content, i.e. the amount of kcal of kJ. This code is called an energy label. The energy label can be any type of symbol considered suitable for the person skilled in the art, for example an integer and/or mathematical symbol.

In a first embodiment, the energy label represents the energy content of 100 g of the actual food product. Specific packages or portions the food product is sold and/or consumed in are not taken into account. The total energy content of the ingested food product can then be calculated by multiplying the energy content per 100 g by the effectively ingested mass.

As an example, but not being limited thereto, food products are divided in five categories: food products with energy labels ‘0’, ‘1’, ‘2’, ‘3’ and ‘+’, each energy label corresponding to a specific energy content:

| Energy label | kcal/100 g |
|---|---|
| + | >400 |
| 3 | 250.1-400 |
| 2 | 150.1-250 |
| 1 | 5-150 |
| 0 | <5 |

For example, energy label ‘1’ is allocated to food products such as fruit and vegetables, boiled ham, lean fromage frais, skinless meat and poultry and yoghurt. Energy label ‘2’ could be assigned to foods such as brown and wholemeal bread, low-fat cheese spread, cured ham, eggs, pork chops and potato croquettes. Energy label ‘3’ could be given to foods such as white bread, raisin bread, Danish pastry, cornflakes, sugary breakfast cereal, mild cheese, salami and chips. Energy label ‘+’ could refer to foods such as nuts, bacon, chorizo, foie gras, dried sausages and crunchy muesli. No solid food products are known with energy label ‘0’. Energy label ‘0’ can only be allocated to low-calorie liquid food products, such as tea.

Another embodiment allocates ranges of kcal values to certain energy labels. These ranges are chosen different for liquid and non-liquid food products. Liquid food products tend to have a much lower energy value than solid food products, mostly because they have a higher liquid content and lower nutrient content. This means that if the same ranges were to be used for liquid and non-liquid food products, most liquid food products would receive the same energy label. This is not desirable, as it would prevent the user from making the required distinction between low-energy drinks, i.e. drinks with a low energy content and high-energy drinks, i.e. drinks with a high energy content. Whereas solid food products are given energy labels ‘0’, ‘1’, ‘2’, ‘3’ and ‘+’ as explained above, liquid food products could be subdivided into energy label categories ‘0’, ‘1’, ‘2’, ‘3’ en ‘+’ based on energy content per 100 ml, as explained below:

| Energy label | kcal/100 ml |
|---|---|
| + | >80 |
| 3 | 50.1-80 |
| 2 | 30.1-50 |
| 1 | 5-30 |
| 0 | <5 |

The total energy content of the ingested food product can then be calculated by multiplying the energy content per 100 ml by the volume of the food product that was effectively ingested.

In another embodiment, energy labels do not refer to the energy content of 100 g or 100 ml of the food product, but they represent the energy content of the specific portion of the product that is being sold/consumed. Such a representation is particularly usable for the energy content of drinks and snacks that tend to be consumed in portions of more than 100 ml or 100 g respectively. Energy label ‘1’ can then be assigned to a cup of coffee with milk and sugar or a piece of fruit. Energy label ‘2’ could be assigned to a glass of fruit juice or one pancake with brown sugar. Energy label ‘3’ would then be assigned to a glass of grape juice or an ice cream cone with two scoops. Energy label ‘+’ would be assigned to a glass of whole chocolate milk or a portion of diced cheese and salami.

Another embodiment assigns energy labels to complete meals and/or recipes and/or menus, because meals, recipes and menus can be developed by experts. So, in addition to controlling the energy content of the ingested food products, it also becomes possible to ensure a balanced and healthy eating pattern with the right amount of saturated and unsaturated fats, sugars, fibres and so on. The individual food products can then be combined into healthy and—if possible—customised food servings.

A combination of one or more of previous embodiments is also possible.

Other energy labels than ‘0’, ‘1’, ‘2’, ‘3’ and ‘+’, can be chosen as deemed appropriate by the person skilled in the art. The range of kcal values assigned to a certain energy label can be chosen differently and could vary for liquid and non-liquid food products or for meals and individual food products.

Summarizing, the first step of the method according to the invention aims to classify food products with energy labels representing the energy content, i.e. the amount of kcal or kJ absorbed when consuming the food product. In other words, the first step generates a first database of a plurality of food product identifications for a multitude of food products and a multitude of energy labels corresponding to each of these food products. The food product identification of a food product can be any kind of identification deemed appropriate by the person skilled in the art to uniquely identify the food product. A non-restrictive example of a product identification can be the food product name and/or brand, the barcode or any other identification as deemed appropriate by professionals. The product's energy content could refer to the energy content of 100 g or 100 ml of the product, the energy content of a standard portion or a combination of these.

The term ‘food product’ can refer to an individual food product, a recipe containing several individual food products, a meal, a menu or any other food product as deemed appropriate by the person skilled in the art.

These energy labels can for instance be included in a first database made available to the consumer through any application as considered suitable by the person skilled in the art. Examples are an online application with a user interface providing database access, a mobile application providing database access to mobile phones, PDAs or smart phones or a scanning application providing database access to devices such as a hand-held scanner or laser pen by scanning food product bar codes. The labels can for instance be applied to the food product packaging in order to provide information on the energy content of the specific food product in a very recognisable and reliable way.

In a next step of the method according to this invention, each of the energy labels defined in the first step is linked to at least one suitable exercise activity needed to expend at least part of the energy absorbed by consuming food products with that energy label. The energy consumed when performing these exercise activities can for instance be calculated based on the ‘activity intensity’ and ‘activity time’ parameters.

Although it might be the case, it is not necessary to offset all energy absorbed through food with exercise. The body needs about 75% of the energy for its proper functioning (metabolism, brains, . . . ). Some people may need a higher energy intake than others, depending on their occupation, height or bodyweight for example. In order to make things easier for the consumer, energy expended through exercise linked to label ‘x’ is preferably calculated based on a quarter of the energy content absorbed with food products linked to the same label ‘x’. In other words, energy expended in an exercise activity linked to energy label ‘x’ preferably equals 25% of the energy absorbed by consuming a food product with the same energy label ‘x’.

Summarizing, the second step of the method according to the invention aims to generate a second database linking at least one exercise activity to each of the energy labels defined in the first step to expend at least part of the energy absorbed by consuming a food product with that energy label.

In a next step of the method according to the invention, the consumer selects an individual food product from a plurality of food products.

Next, a first control unit performs a search of the first database and generates the individual energy label corresponding to the specific food product.

Based on a search of the individual energy label in the second database, at least one corresponding individual exercise activity is generated by a second control unit, which can be the same as or different from the first control unit.

For each food product selected by the consumer, this method generates at least one exercise activity required to offset at least part of the absorbed energy content of the food product selected by the consumer. This allows the consumer to know clearly at any time of the day which exercise activity or activities he or she should still engage in.

The main advantage of the method according to the invention is that calculators or scales are no longer required to calculate, perceive or monitor the amount of calories absorbed through food, i.e. the energy consumption. In the existing methods, the absorbed energy content of a food product can only be known by studying the packaging details, which often provide too much information, and by calculating the amount of absorbed energy in kcalories and/or kJ by using a specific calculation system. Because users are usually not familiar with these units, it is difficult for them to use and interpret the final result. Controlling the energy balance is complicated, because users find it difficult to correctly interpret the information on the packaging and the calculated end result and because they don't know which activity is required to offset the energy delivered upon consumption of a food product. By allocating a simple energy label to each food product, such as ‘0’, ‘1’, ‘2’, ‘3’, of ‘+’ codes, users can very easily gain an understanding of the energy content of a particular food product without having to read any other information on the packaging and without having to make any calculations. Once an individual food product is selected, at least one exercise activity is immediately generated. Once users select an individual food product, they are immediately informed which exercise activity is required to offset the absorbed energy.

According to the invention's method, a simple comparison of the total energy label values and total activity label values at the end of the day or week is enough to understand the energy balance of that day or week. Even in the course of the day, users can easily get a rough idea of the energy absorbed through food that should be offset by exercise, simply by comparing the energy labels of the food products they ate to the energy labels of the exercise activities they completed.

According to the invention, there is also an option to implement the method the other way round: based on a completed exercise activity, one or more food products can be suggested of which the energy content is in line with the energy expended during the completed exercise activity.

Each food serving with energy label ‘x’ is preferably offset by an activity with the same energy label ‘x’. However, the energy balance can also be assessed per day or per week. A day is balanced when the energy absorbed through food is offset by the energy expended by exercise. This means that the sum of the food energy labels for that day should match the sum of the day's exercise energy labels. If insufficient exercise activities are undertaken on a day when high-energy food products are ingested, this should be offset by additional exercise activities in previous or subsequent days.

The daily energy level is preferably determined by adding up all the ingested food product energy labels and by dividing the result by the number of food servings, in other words by calculating a food product energy label average. A level ‘1’ balanced day means that low-energy food was ingested and little or low-impact exercise occurred. A level ‘3’ balanced day means that high-energy food was ingested and offset by intensive exercise activities expending a lot of energy. Contrary to existing methods that require consumers to keep their daily energy levels as low as possible, consumers using this method can vary their daily energy levels. For example, they could have two ‘1’ days, two ‘2’ days, two ‘3’ days and one ‘+’ day.

This method is particularly useful when designing a system to help consumers control their body energy balance. Such a system preferably comprises a reader unit for reading a product identification of a food product which uniquely identifies the food product, a first control unit connected to the reader unit for looking up the food product identification in a first database in a first memory and generating a food product energy label representing the food product's energy content, a second control unit connected to the first control unit for looking up the food product's energy label in a second database in a second memory and generating at least one exercise activity to offset at least part of the absorbed energy content of the food product.

In a non-restrictive example, the system could use a laser pen or a hand-held scanning device also used in many supermarkets to scan bar codes. The product identification could be any code uniquely identifying the product, such as a barcode, numeric code or letter code. In the example of the scanning system, the barcode mentioned on the packaging of a certain food product can uniquely identify the food product, i.e. type, weight, . . . .

This information is then passed on to the system's first control unit. This control unit is connected to a first memory, which contains a first database of food product identifications and their corresponding energy labels.

The energy label represents the energy content of the food product, i.e. the energy absorbed by the body when ingesting the food product in question. The energy label can represent the energy content of 100 g, a standard portion or the portion sold and/or consumed.

The first memory can be incorporated into the system itself or can be an external memory that is connected to the system.

The energy label can optionally be visually represented to the consumer on a first representation unit connected to the first control unit. The first representation unit can for instance be the computer screen, scanning system or mobile phone. The energy label can for instance be a limited series of integers, such as ‘0’, ‘1’, ‘2’ and ‘3’, which may or may not be combined with a mathematical symbol ‘+’. ‘0’ refers to a very low energy content and ‘+’ to a very high energy content. Any other possibility deemed appropriate by the person skilled in the art is possible on the condition that the energy content of the product in question is recognised very quickly and easily.

The first control unit can be connected to a second control unit to which the energy label is passed on. This second control unit is connected to a second memory comprising a second database of a plurality of exercise activities, each with a corresponding energy label.

Like the first memory, the second memory can be incorporated into the system itself or can be an external memory connected to the system. The first and second memories can be a joint memory or two separate memories.

The first and second control units can be separate units, make up a single control unit or be part of the same unit.

Summarizing, every food product is linked to an energy label and at least one exercise activity required to offset the energy absorbed when consuming the food product in question. The same energy label can therefore represent the energy content of a certain food product as well as the activity or activities required to offset this energy.

This activity or activities can then be shown to the consumer on a second representation unit connected to the second control unit.

The first and second representation units can be one and the same unit or can be different units.

Optionally, a list of activities can be generated from which the consumer can choose. The list can also be customised to the preferences profile of that specific consumer.

The method according to the present invention can also be used in an online application allowing users to manually enter a product identification and go through the same steps as in the scanning system.

A similar application can be integrated in mobile phones or smart phones. Mobile phones can be modified to scan food products or provide a user interface to manually enter product identifications.

The energy label or an additional label can be provided to give information on the amount of certain nutrients in the food product, such as salt, sugar, fibre, (saturated and/or unsaturated) fatty acids, vitamins or minerals. Energy labels ‘0’, ‘1’, ‘2’, ‘3’, and ‘+’ as described above could also be used to indicate whether certain food products contain (almost) no (‘0’), little (‘1’), an average amount (‘2’), a large amount (‘3’) or a very large amount (‘+’) of a certain nutrient, a so-called food product nutrient level. The energy label given to a certain nutrient, the nutrient label, can be determined by professionals, based on parameters such as nutrient mass or the percentage of the daily recommended amount of that nutrient provided. The nutrient label can also provide an indication of the daily recommended dose of a certain nutrient, whereby nutrient label ‘1’ could stand for 0-25% of the daily recommended amount of the nutrient, nutrient label ‘2’ could stand for 25%-50% of the daily recommended amount of the nutrient, . . .

Similar to the energy labels, these nutrient labels can be used to allocate a nutrient level to full meals and/or recipes and/or menus according to another embodiment of the invention. These nutrient labels can be shown to users, for example by printing them on the menu or packaging or they can be scanned to provide users an immediate indication of the content of a certain nutrient in a food product and/or menu and/or recipe. This is particularly useful for people who should only take in a certain amount of a particular nutrient for health reasons, such as diabetics.

These nutrient labels can be added to the first database, which can then be accessed by one of the above applications, for example with a scanning system or in an online application. As an option, users could receive this information on a third representation unit of the scanning system or user interface, which could be the same as or different from the first and/or second representation unit.

One or more label types—nutrient labels, energy labels and exercise labels—can be used in a method and system to select food products based on users' health profiles.

In a second aspect of the invention, the invention is related to a system to select one or more food products based on the individual's health profile.

The health profile includes a reference nutrient label for at least one nutrient in the food product, which presents the nutrient's maximum permissible value for the individual. For example, for a diabetic, the health profile could contain a reference sugar label representing the maximum permissible amount of sugar the individual is allowed to have. Other unrestrictive examples are health profiles for people with high blood pressure, for whom the health profile should contain a reference salt label to indicate the maximum salt content in food products, or people with high cholesterol, for whom the health profile should contain information on the permitted amount of saturated fats.

This personalised information on users' state of health could be stored on a memory card that can be connected to the scanning system, such as a laser pen or mobile phone. The card could also be inserted into the device or its information could be uploaded before starting the application in question. After scanning the food product or accessing the food product online, a warning can be generated and shown on a system representation unit. If the user is a diabetes patient, a warning could be generated when food products are scanned with nutrient labels higher than ‘1’. The nutrient label is used here to select food products that meet a certain user health profile.

As an unrestrictive example, a method is described using the invention's energy and nutrient labels for food products in an online application.

In a first step, the user enters a food product or food product identification in a search engine. After typing in this information, one or more of the following information types appear on the screen: the product image, energy label and nutrient label of one or more food products. The user then has the option to move on to the next step.

In an optional second step, the user can choose to access more detailed information on the nutritional value of the food product in question, which could include the product's exact energy content and the exact amount of one or several nutrients in the food product, the country of origin, . . .

In an optional third step, the user can then receive a suggestion on how to use the food product—usually in the form of a recipe—and/or the user can receive a suggestion on one or more exercise activities for this energy label. As an option, these activities can be personalised based on the user's health profile, which can be stored in a database or on a memory card that can be linked to or inserted into the computer or system.

In an optional fourth step, the user can receive information based on his health profile, which could contain a warning about consuming the food product.

A similar method can be used in a scanning system or mobile phone application or any other system deemed appropriate by the person skilled in the art.

The system to select a food product based on an individual's health profile includes a reader unit reading a food product identification uniquely identifying the food product and a first control unit linked to this reader unit. The first control unit can look up the food product identification in the first database in the first memory and can also generate information linked to the food product based on a search of this first database.

The individual's health profile may include personalised information on his or her state of health. The health profile may for instance comprise a reference nutrient label, which suggests a maximum amount of specific nutrients for the individual.

The product information includes a nutrient identification for at least one nutrient present in the food product and a linked nutrient label. One or more nutrients are uniquely identified by nutrient identifications. The quantities of one or more nutrients in the food product are represented in nutrient labels.

A nutrient label could be any label deemed appropriate by the person skilled in the art, but is preferably chosen from the group of energy labels.

The system also includes a second control unit linked to the first control unit. This second control unit compares the nutrient label with the reference nutrient label for that particular nutrient, which is stored in a second database in a second memory. The second control unit then generates an output signal to the individual based on this comparison. This signal could be a warning if the food product selected by the individual exceeds the reference nutrient label value.

Similar to the system of the invention's first aspect, the first memory and/or second memory can constitute a joint memory or can be two separate memories. The first and second control units can be separate units or one joint control unit. One or several instances of the nutrient identification, the nutrient label, reference nutrient label and generated output signal can be shown to the user on one or several representation units.

As an option, the system and/or method according to the invention can also be used by the food service industry for one or several aspects of the invention. For example, an energy label and/or nutrient label can be shown on the menu for one, preferably several, or even more preferably all meals and/or menus. This provides the consumer with immediate information on the energy content of specific meals and/or menus and on the amount of one or several nutrients in these specific meals and/or menus. Food service establishments could optionally also suggest at least one exercise activity to the consumer for each energy label. These exercise activities should preferably be available near the food service establishment. Food service establishments could optionally also integrate their meals and/or menus in the first database of the method according to one of the invention's aspects and make them available to the consumer through a search engine or laser system.

1. Method for controlling an individual's energy balance when consuming a food product, comprising the following steps: generating a first database comprising a plurality of product identifications, each of the plurality of product identifications uniquely identifying a food product, the first database further comprising a plurality of corresponding energy labels, each of the energy labels representing an energy content of the food product, characterized in that the method further comprises the following steps:
generating a second database which comprises for each of the plurality of energy labels from the first database at least one corresponding exercise activity, the at least one corresponding exercise activity resulting in an energy expenditure offsetting at least part of the energy absorbed by ingesting the food product with that energy label,
selecting an individual food product from the plurality of food products,
generating a corresponding individual energy label for the individual food product from the first database,
generating at least one individual exercise activity with the corresponding individual energy label from the second database.

2. Method according to claim 1, characterised in that the plurality of energy labels is chosen from a group consisting of ‘0’, ‘1’, ‘2’, ‘3’ and ‘+’.

3. Method according to claim 2, characterised in that the plurality of energy labels is calculated based on the amount of kcal in 100 g of the individual food product.

4. Method according to claim 2, characterised in that the plurality of energy labels is calculated based on the amount of kcal in 100 ml of the individual food product.

5. A system for controlling an energy balance of an individual when consuming a food product, comprising:
a first reader unit for reading a product identification of the food product which uniquely identifies the food product,
a first control unit connected to the first reader unit provided for searching the product identification of the food product in a first database of a first memory and for generating product information related to the food product based on information in the first database,
characterized in that:
the product information comprises an energy label representing the energy content of the food product.
the system further comprising a second control unit connected to the first control unit, the second control unit being provided to look up the energy label of the food product in a second database of a second memory and for generating at least one exercise activity to offset at least part of the energy absorbed by consuming the food product with that energy label.

6. A system according to claim 5, characterised in that the system comprises a first representation unit connected to the first control unit to visually represent the energy label of the food product.

7. A system according to claim 5, characterised in that the system comprises a second representation unit connected to the second control unit to visually represent the at least one exercise activity of the food product.

8. A system according to claim 6, characterised in that the first database comprises at least one nutrient identification for each of the plurality of food products uniquely identifying a nutrient in the food product and a nutrient label for each of the nutrient identifications representing the amount of the nutrient present in the food product.

9. A system according to claim 8, characterised in that the system further comprises a second reader unit for reading the nutrient identification of the at least one nutrient in the food product.

10. A system according to claim 9, characterised in that the system further comprises a third representation unit to visually represent the at least one nutrient label of the at least one nutrient.

11. A system for selecting a food product based on a health profile of an individual, the food product comprising at least one nutrient, the health profile of the individual comprising a reference nutrient label for the at least one nutrient which represents a maximum permissible value of that nutrient for the individual, the system further comprising:
a reader unit for reading a food product identification of the food product uniquely identifying the food product,
a first control unit connected to the reader unit to search for the food product identification in a first database in a first memory and to generate product information related to the food product based on a search in the first database,
characterized in that:
the product information comprises at least one nutrient identification and corresponding nutrient label, whereby the nutrient identification uniquely identifies the at least one nutrient and the nutrient label represents the amount of that particular nutrient present in the food product,
the system comprises a second control unit connected to the first control unit provided to compare the nutrient label to the reference nutrient label for the at least one nutrient stored in a second database in a second memory and to generate an output signal based on this comparison to the individual.
